(19) United States
(12) Patent Application Publication
(10) Pub. No.: US 2011/0305866 A1
(43) Pub. Date: Dec. 15, 2011

(54) Surfing towel assembly with fasteners

(76) Inventor: Jonathan Stowe, Greenbrae, CA (US)

(21) Appl. No.: 12/802,814

(22) Filed: Jun. 14, 2010

(51) Int. Cl. B32B 3/06

(52) U.S. Cl. 428/100; 428/99

(57) ABSTRACT

The applicant's invention is a universal surfing towel for the following purposes: One, it can function as a normal beach towel similar to a conventional bath towel with either bamboo or terry cotton material. Two, the towel can be used by any size surfer for changing; one of the two fastening systems built into the towel functions as a wrapping aid to effectively hold the towel to the surfer's body, providing privacy and ease of changing in and out of a wetsuit. Lastly, the second fastening system built into the towel will allow for the towel to be wrapped around a surfboard, providing protection for the surfboard during transport; additionally, the second fastening system can be easily attached to any rack, hook, bar, or handrail for more effective drying.

### RELATED APPLICATIONS

The present application is related to U.S. Pat. No. 6,859,940, issued Mar. 1, 2005, for SURFER'S WET SUIT SKIRT/WRAP, by Michael Sholander, included by reference herein.

The present application is related to U.S. Pat. No. 3,381,306, issued May 7, 1968, for INNES MULTIPURPOSE BLANKET, by G. C. Innes, included by reference herein.

The present application is related to U.S. Pat. No. D299580, issued Jan. 31, 1989, for COMBINATION BEACH TOWEL AND BEACH COVER-UP, by Oscar A. Hansen, included by reference herein.

The present application is related to U.S. Pat. No. 5,611,083, issued Mar. 18, 1997, for CHANGING ROBE, by Barbara A. Arnold, included by reference herein.

The present application is related to U.S. Pat. No. 6,665,882, issued Dec. 23, 2003, for SURFING SHORTS WITH WETSUIT UNDERGARMENT, by Webster Pedrick, included by reference herein.

The present application is related to U.S. Pat. No. 6,675,389, issued Jan. 13, 2004, for GARMENT WITH ZIPPERS ENABLING EASY ACCESS, by Louise Marie Kublick, included by reference herein.

The present application is related to U.S. Pat. No. 2,344,010, issued Mar. 14, 1944, for COMBINATION BEACH ROBE, by H. B. Walsh, included by reference herein.

The present application is related to U.S. Pat. No. 2,420,344, issued May 13, 1947, for BEACH TOWEL AND GARMENT, by V. C. Alexander, included by reference herein.

The present application is related to U.S. Pat. No. 5,797,142, issued Aug. 25, 1998, for GOLF TOWEL ASSEMBLY, by Nicholas Debronsky Jr. et al, included by reference herein.

The present application is related to U.S. Pat. No. 5,012,543, issued May 7, 1991, for ATHLETIC TOWEL, by John Lewis et al, included by reference herein.

The present application is related to U.S. Pat. No. 6,186,155, issued Feb. 13, 2001, for SPA TOWEL, by David Alan Cheek, included by reference herein.

The present application is related to U.S. Pat. No. 5,072,467, issued Dec. 17, 1991, for BEACH TOWEL WITH POCKETS, by Sean P. Hunt, included by reference herein.

The present application is related to U.S. Pat. No. 5,261,131, issued Nov. 16, 1993, for BEACH BLANKET ASSEMBLY, by Kevin B. Kilby, included by reference herein.

The present application is related to U.S. Pat. No. 5,406,659, issued Apr. 18, 1995, for BEACH TOWEL, by Gary L. Camp, included by reference herein.

The present application is related to U.S. Pat. No. 10,891,761, issued Mar. 3, 2005, for BEACH WRAP, by Maureen Flanagan-Frazier, included by reference herein.

### FIELD OF THE INVENTION

This invention generally relates to a towel assembly and particularly to a surfing towel assembly that easily attaches to a surfer, a surfboard, or a car roof rack for coverage, protection, and drying. The invention also relates to a surfer equipped with the surfing towel assembly and to a method of attaching the towel to the surfer's body, a surfboard, or a car roof rack.

### BACKGROUND OF THE INVENTION

Surfing, is a sport enjoyed by millions of people worldwide. Increasingly, about 1/3 of all surfers are women. Most surfers do not live at the water's edge and must travel to the water by car or public transport. Many surfers also wear wetsuits, as dictated by the water temperature of the surfing location. This requires that the surfer transport a board without it being damaged, a wetsuit, as well as a towel to the surfing beach or break. If there are no facilities for changing they must also have a method of covering up their body while changing into or out of their wetsuit. While there are garments (skirts and robes) for changing, most surfers simply use a towel for this purpose. The towel is wrapped around the surfer's waist or (for women) their chest. Next, the surfer removes his or her pants or shorts and often, their underwear. The surfer may put on a swimsuit and then pulls the wetsuit, one leg at a time onto their lower body. Because the wetsuit is tightly fitting, there is considerable effort in getting the wetsuit on. Then, the surfer removes his or her shirt. Most women wear a bikini swimsuit top under their wetsuit and may put this on at the same time. Finally, the surfer removes the towel and pulls the wetsuit up over their chest, securing it with a zipper. After this, the surfer is ready to go surfing. The towel may become dislodged at any point in the changing process causing unwanted exposure and general perturbation. Most surfers agree that wearing a wetsuit is much easier than getting into or out of one.

When the surfer concludes their surfing session, they reverse the process. First, they unzip the wetsuit and remove the upper portion of it by pulling it off, one arm at a time and then down to their waist. Then, they often dry the upper portion of their body with the towel and then wrap the towel around their waist or (with women) their chest. If it is cold, the surfer may put on their shirt before removing the remainder of the wetsuit from their body. Then they peel the wetsuit off their lower body, one leg at a time. Next, they use the towel to dry off their lower body by patting it down around them. Then they pull on their underwear and pants. As they pull up their pants, they must temporarily discard the towel, often dropping it on the ground. Later, they pick up the towel and often use it to dry their surfboard.

As the surfer leaves the surfing beach or break, some surfers wrap the towel around the surfboard to protect the board and carry the towel. Other surfers place the wet towel in a bin or bag with the wetsuit. Regardless, the surfer must somehow transport the wet towel back to their residence and dry it.

The majority of surfers use a beach towel for drying themselves and their board as well as covering up during changing. The size of a beach towel is not ideal for this use as it is often wider than the height of the surfer's waist and drags along the ground. The towel is often constructed of man-made fibers and it is not as absorbent as it needs to be. There is no way to attach the towel to anything during the initial or latter part of the changing process to keep it from falling on the ground where, because it is wet, it will pick up dirt more easily. There is also no way of attaching the towel to the surfboard or to the roof rack of the car for drying on the way home. As a result, most dirty, wet towels are simply put into a bin or bag with the wetsuit and become even more water logged and dirty. Some surfers attach the towel to their surfboard or roof rack to facilitate drying it on the way home. They do this by tying it. Often the towel comes loose during transport, creating a hazard for other motorists and often being discarded by the side of the road.

Previously garments (skirts, wraps, and robes) were created for changing. These garments were generally designed for bathers of all types and may be made of various fabrics including terrycloth panels to absorb water. In one instance (U.S. Pat. No. 6,859,940), the garment was designed as a cover-up towel but it slipped over the head rather than fastened about the waist. However, many of these garments are complex and have many components or features such as hoods, elastic waistbands, and other components that prevent the towel from laying out flat or maintaining its rectangular shape. An example is the Surfer's wet suit skirt/wrap (U.S. Pat. No. 6,859,940) which includes multiple fabric pieces, additional fabric materials, slits in the side of the garment to allow for access, pockets, drawstrings, casing channels, and other methods of attachment.

All of these inventions prevent the prior art from functioning as a normal towel. The shape of these inventions are generally not rectangular for use as a normal towel. None of these devices can be laid out completely flat for use on the beach, laid across the top of a surfboard or pulled across the back, head, and arms for drying.

Additionally, the complexity of these devices add to the device's cost and is generally not appealing for use by surfers who favor simplicity of design and function.

Further, the length of the garments will not work for women because the length is not sufficient for coverage over the chest. This is a significant problem because more and more women surf.

The materials used in these products may be man made or natural. When a preference for natural materials exists as it often does among surfers, the use of man made materials may prevent the device from being attractive to the consumer.

Finally, none of these devices have fastening systems for a surfboard or for use in attaching the device to a hook or rack.

### SUMMARY OF THE INVENTION

One embodiment of the surfing towel assembly is a rectangular terry cloth towel comprised of 100% cotton fiber, 100% bamboo fiber or some combination of the two fibers. This fiber, once woven into terry cloth is ideal for use by a surfer because it is more absorbent, facilitating use for both the surfer and his/her surfboard. In addition, both cotton and bamboo are naturally derived materials as opposed to polyester or other man-made material because the scent and the feel of the fabric are critical to the design.

The length (longest side or side) of the towel facilitates the towel to be used by the average adult male or female around the hips or chest (100-200 centimeters). In addition, the length of the longest side of the towel facilitates the towel to be used as a wrap around a surfboard. The width (shortest side or end) of the towel (40-140 centimeters) sufficiently covers the lower torso and legs or the upper body and lower torso of the average adult male or female. A towel that is larger than the largest size combination of this towel is too large to be used effectively in the means provided by the fastening systems.

The surfing towel assembly has two fastening systems comprised of:

A first fastening system: The front side of the upper left edge of the longest side of the towel has the hook side of a hook and loop fastener system that is between 1 centimeter and 3 centimeters in width affixed to it. The backside of the upper right edge of the longest side of the towel has the corresponding piece of the hook and loop fastener system affixed to it. The length of each piece of the hook and loop fastener system is between 40 and 62 centimeters.

Second fastening system: The front, right bottom corner of the longest side of the towel has a cloth gusset affixed to it for the purpose of reinforcement of the towel at the corner. A plastic or metal eyelet is attached through both the gusset and the towel. The backside of the left bottom corner of the longest side of the towel has a similar cloth gusset affixed to it for reinforcement of the towel at the corner. A second plastic or metal eyelet is attached through both the second gusset patch and the towel. A spring-loaded plastic clip, or metal carabineer is attached to a eyelet.

Although the description above contains many specifications, these should not be considered to limit the scope of the invention but as providing illustrations of some of the presently preferred embodiments of this invention. Thus, the scope of the invention should be determined by the appended claims and their legal equivalents, rather than by the examples given.

Accordingly, the reader will see that the surfing towel assembly can be used in a variety of applications easily and conveniently and with minimal instruction. The towel can be laid flat on the sand or used to sponge water off of the surfer in the same manner as any common beach towel. The simplicity of the design requires no special or time consuming manufacturing processes such that the cost of manufacture is low and makes the cost lower than any similar invention. The length of the surfing towel assembly is sufficient to fully cover a person from the chest down and is thus appropriate for women. The towel material is natural fiber and appeals to the consumer concerned with using a natural product against their body. Finally, the surfing towel assembly has a second fastening system which allows the device to be used to attach to a surfboard to protect it or to a hook or rack for drying.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front schematic view of a surfing towel assembly with corresponding parts list;

FIG. 2 is a section view of a surfing towel assembly illustrating the components from a side view;

FIG. 3 is a front partial view of the present embodiment of the invention as it is applied to a male surfer's body using fastening system #1;

FIG. 4 is a front partial view of the present embodiment of the invention as it is applied to a female surfer's body using fastening system #1;

FIG. 5 is a front partial view of the present embodiment of the invention as it is applied to a surfboard using fastening system #1;

FIG. 6 is a partial view of the present embodiment of the invention as it is applied to a car roof rack using fastening system #2; and

FIG. 6a is a detail view of the present embodiment of the invention as it is applied to a car roof rack using fastening system #2.

For purposes of clarity and brevity, like elements and components will bear the same designations and numbering throughout the Figures.

### DESCRIPTION OF THE PREFERRED EMBODIMENT

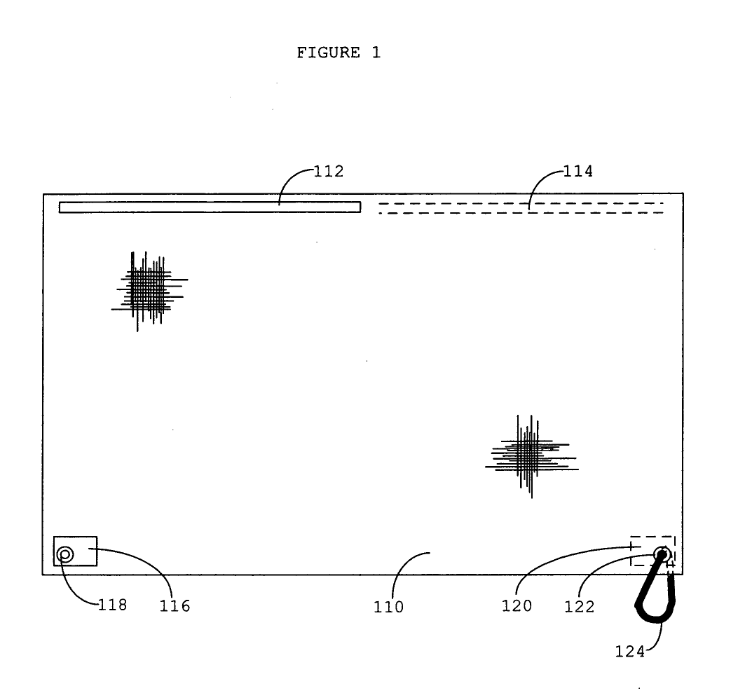

A typical embodiment of the surfing towel assembly of the present invention is illustrated in FIG. 1. The surfing towel assembly has an elongated, substantially rectangular shaped main body portion of Terry cotton and/or bamboo Towel 110 having a pair of side edges and a pair of ends, size being 100-200 centimeters on the longest side (side) edges and 40-140 centimeters on the shortest sides (ends).

The front side of the upper left edge of the side of the terry cotton and/or bamboo towel has Fastening System One: strip #1 (loop in hook and loop fastener) 112 that is between 1 centimeter and 3 centimeters in width affixed to it. The backside of the upper right edge of the side of the terry cotton and/ or bamboo towel has the corresponding piece Fastening System One: strip #2 (hook in hook and loop fastener) 114 affixed to it. The length of each piece of the hook and loop fastener system is between 40 and 62 centimeters. Together these two pieces of hook and loop fasteners comprise Fastening System One.

The position of the hook and loop portion of the fastening system may be reversed such that the front side of the upper left edge of the side of the Terry cotton and/or bamboo Towel 110 may have Fastening System One: strip #1 (loop in hook and loop fastener) 112 and the backside of the upper right edge of the side of the terry and/or bamboo towel may have Fastening System One: strip #2 (hook in hook and loop fastener) 114. The method of attachment of the hook and loop system to the surfing towel assembly may be fabric adhesive (thermal or chemical) or mechanical with a sewing process using nylon, polyethylene monofilament, or cotton. A combination of attachment methods may be used.

Fastening System Two is comprised of Fastening System Two: cloth gusset #1 116, Fastening System Two: metal or plastic eyelet #1 118, Fastening System Two: cloth gusset #2 120, Fastening System Two: metal or plastic eyelet #2 122, and Fastening System Two: plastic spring-loaded clip or metal carabineer 124.

The front, right bottom corner of the side of the Terry cotton and/or bamboo Towel 110 opposite Fastening System #1 has the Fastening System Two: cloth gusset #1 116 permanently attached to it for the purpose of reinforcement of the at the corner of the Terry cotton and/or bamboo Towel 110. A second purpose of the Fastening System Two: cloth gusset #1 116 is to display the product name and identifying information. The method of attachment of the Fastening System Two: cloth gusset #1 116 to the surfing towel assembly may be fabric adhesive (thermal or chemical) or mechanical with a sewing process using nylon, polyethylene monofilament, or cotton. A combination of attachment methods may be used. Fastening System Two: metal or plastic eyelet #1 118 is permanently attached through both the Fastening System Two: cloth gusset #1 116 and the Terry cotton and/or bamboo Towel 110.

The backside of the left bottom corner of the side of the Terry cotton and/or bamboo Towel 110 has Fastening System Two: cloth gusset #2 120 permanently attached to it for reinforcement of the Terry cotton and/or bamboo Towel 110 at the corner. A second purpose of the Fastening System Two: cloth gusset #2 120 is to display the product name and identifying information. The method of attachment of Fastening System Two: cloth gusset #2 120 to the surfing towel assembly may be fabric adhesive (thermal or chemical) or mechanical with a sewing process using nylon, polyethylene monofilament, or cotton. A combination of attachment methods may be used. Fastening System Two: metal or plastic eyelet #2 122 is permanently attached through both the Fastening System Two: cloth gusset #2 and the Terry cotton and/or bamboo Towel 110.

Fastening System Two: plastic spring-loaded clip metal carabineer is attached to one of the Fastening System. Two: metal or plastic eyelet #1 118 or Fastening System Two: metal or plastic eyelet #2 122.

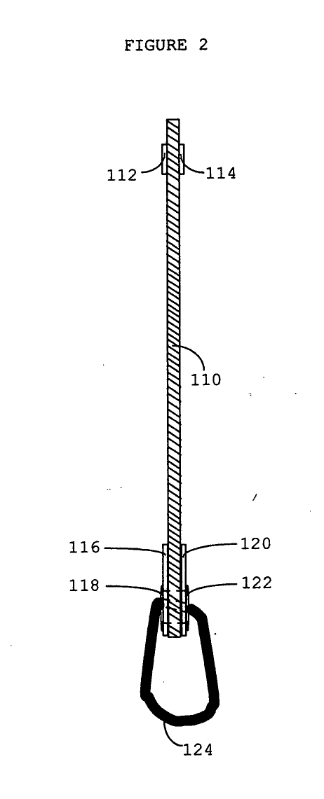

FIG. 2 is a side section view of the surfing towel assembly of the present invention.

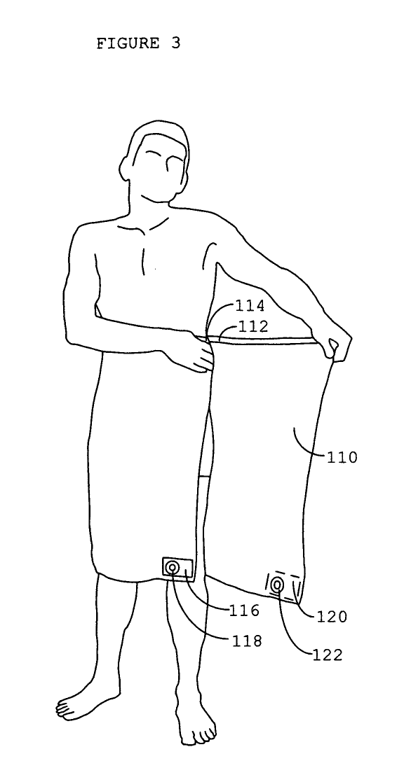

FIG. 3 shows the process of attaching the present embodiment of the surfing towel assembly around a male surfer's body using Fastening System One: strip #1 (loop in hook and loop fastener) 112 and Fastening System One: strip #2 (hook in hook and loop fastener) 114. The male surfer lays one end of the towel against their body and begins to wrap the towel assembly around their waist. It is important to note that the towel assembly does not require a specific end to be first placed against the surfer. The unique design allows for either end of the towel assembly to work equally well. Also note that the Fastening System One: strip #1 (loop in hook and loop fastener or Fastening System One: strip #2 (hook in hook and loop fastener) 114 are facing out and away from the surfer's body.

Once the towel assembly is wrapped around the surfer with the Fastening System One: strip #1 (loop in hook and loop fastener) 112 or Fastening System One: strip #2 (hook in hook and loop fastener) 114 facing towards the surfer's body and ready to be joined to the first hook and loop strip. The surfer is still holding the towel against their body, mating Fastening System One: strip #1 (loop in hook and loop fastener) 112 and Fastening System One: strip #2 (hook in hook and loop fastener) 114 together. The length of the side of the Terry cotton and/or bamboo Towel 110 and the length of the Fastening System One: strip #1 (loop in hook and loop fastener) 112 and Fastening System One: strip #2 (hook in hook and loop fastener) 114 are designed to allow this to work for any waist or chest size. The surfer is now ready to change in or out of their wetsuit.

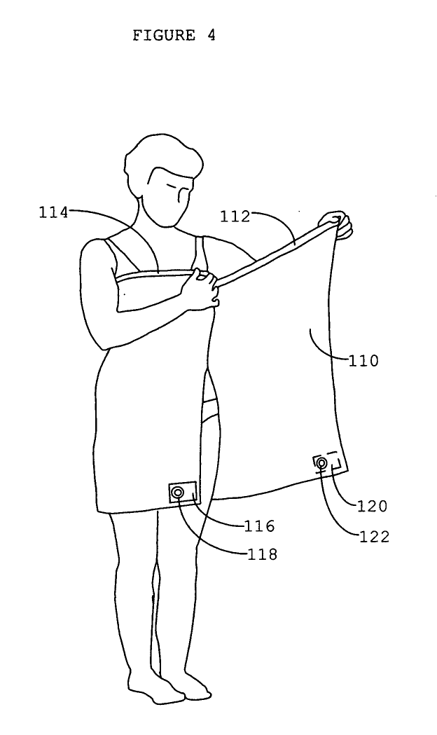

FIG. 4 shows the process of attaching the present embodiment of the surfing towel assembly around a female surfer's body using Fastening System #1. The female surfer lays one end of the towel against their upper body and begins to wrap the towel assembly around their chest. The surfer attached the towel to her body similar to the process described in FIG. 3. The length of the surfing towel assembly is sufficient to fully cover a person from the chest down and is thus appropriate for women because the length of the side of the Terry cotton and/or bamboo Towel 110 and the length of the Fastening System One: strip #1 (loop in hook and loop fastener) 112 and Fastening System One: strip #2 (hook in hook and loop fastener) 114 are designed to allow this to work for any chest size. The surfer is now ready to change in or out of her wetsuit.

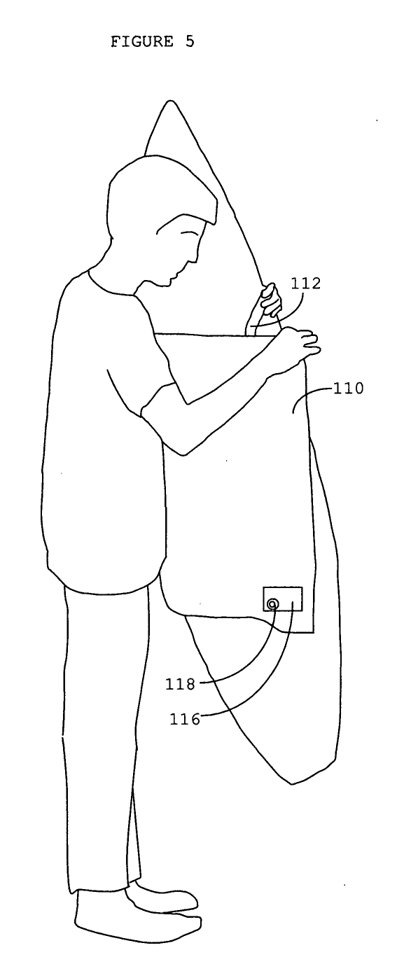

FIG. 5 shows the process of attaching the present embodiment of the surfing towel assembly around a surfboard using Fastening System One: strip #1 (loop in hook and loop fastener) 112 and Fastening System One: strip #2 (hook in hook and loop fastener) 114. The surfer lays one end of the towel against the surfboard and begins to wrap the towel assembly around it. It is important to note that the towel assembly does not require a specific end to be first placed against the surfboard. The unique design allows for either end of the towel assembly to work equally well. Also note that the Fastening System One: strip #1 (loop in hook and loop fastener) 112 and Fastening System One: strip #2 (hook in hook and loop fastener) 114 are facing out and away from the surfboard.

The surfer then mates Fastening System One: strip #1 (loop in hook and loop fastener) 112 and Fastening System One: strip #2 (hook in hook and loop fastener) 114 together. The length of the side of the Terry cotton and/or bamboo Towel 110 and the length of the Fastening System One: strip #1 (loop in hook and loop fastener) 112 and Fastening System One: strip #2 (hook in hook and loop fastener) 114 are designed to allow this to work for any surfboard. In addition, Fastening System #2 (Fastening System Two: cloth gusset, Fastening System Two: metal or plastic eyelet #1 118, Fastening System Two: cloth gusset #2 120, Fastening System Two: metal or plastic eyelet #2 122 and Fastening System Two: plastic spring-loaded clip or metal carabineer 124) may be used to provide a second means of attachment to the surfboard. The surfer is now ready to transport their surfboard and towel.

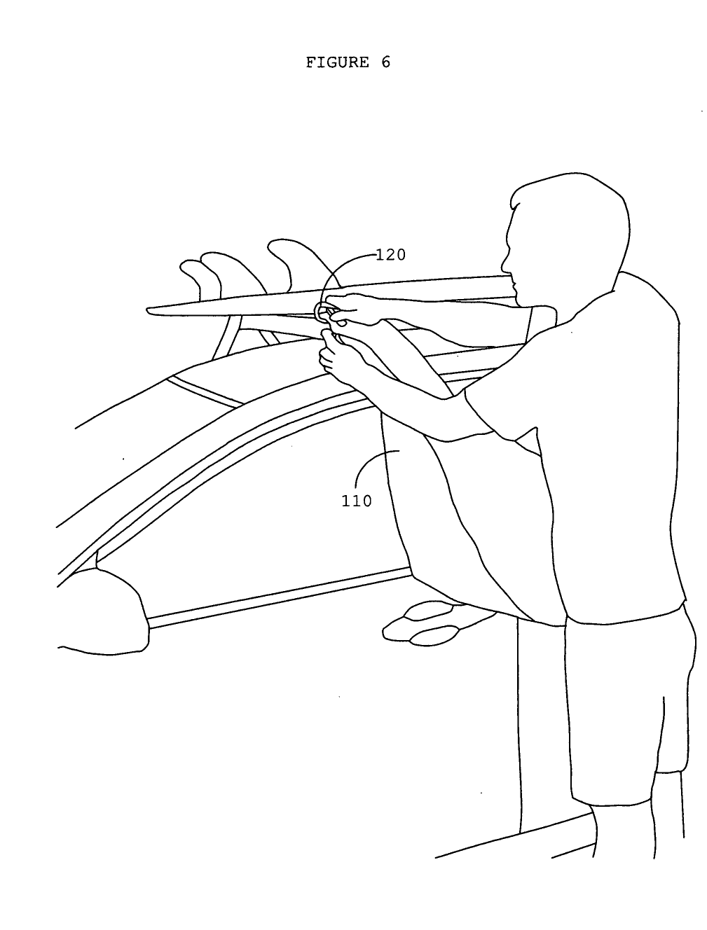

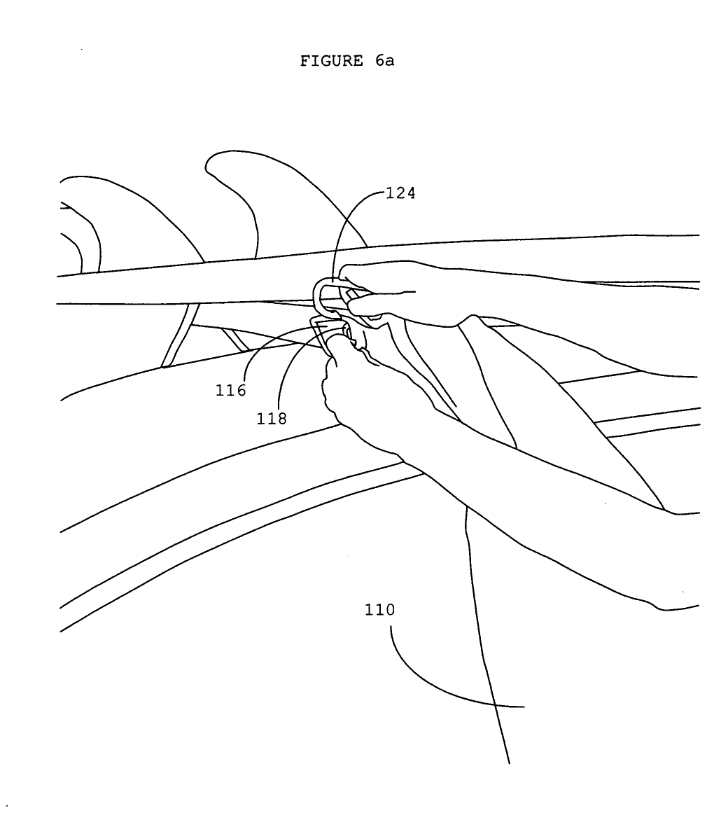

FIG. 6 shows the process of attaching the present embodiment of the surfing towel assembly around a car roof rack using Fastening System #2 (Fastening System Two: cloth gusset, Fastening System Two: metal or plastic eyelet #1 118, Fastening System Two: cloth gusset #2 120, Fastening System Two: metal or plastic eyelet #2 122 and Fastening System Two: plastic spring-loaded clip or metal carabineer 124). The surfer takes Fastening System Two: metal or plastic eyelet #1 118 and Fastening System Two: metal or plastic eyelet #2 122 in hand and moves towards the car with side of the towel containing Fastening System #2 positioned close to the roof rack of the car.

The surfer grasps the Fastening System Two: plastic spring-loaded clip or metal carabineer 124 in one hand and the corresponding Fastening System Two: metal or plastic eyelet #1 118 or Fastening System Two: metal or plastic eyelet #2 122 in the other hand. The surfer brings Fastening System Two: plastic spring-loaded clip or metal carabineer 124 to Fastening System Two: metal or plastic eyelet #1 118 or Fastening System Two: metal or plastic eyelet #2 122 and attaches them together. The surfing towel assembly is now ready for transport. It is important to note that this method of transport for will both dry the Terry cotton and/or bamboo Towel 110, blow any sand or debris from it, and will not scratch or harm the car in any way as all facets of the Fastening Systems soft and flexible with the rest of the material of the Terry cotton and/or bamboo Towel 110.

FIG. 6a is a detailed view of the present embodiment of the invention showing the process described in FIG. 6.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A surfing towel assembly with fasteners for coverage, protection, and drying, comprising:
means for drying and covering the surfer or surfboard;
means for attaching the surfing towel assembly to a surfer or surfboard, permanently connected to said means for drying and covering the surfer or surfboard;
means for attaching the surfing towel assembly to a surfer or surfboard, permanently embedded to said means for drying and covering the surfer or surfboard;
means for reinforcing the towel where the metal or plastic eyelet attaches to it, permanently connected to said means for drying and covering the surfer or surfboard;
means for providing a secure means of attaching the plastic spring-loaded clip or metal carabineer to the towel and to hand the towel on a hook, permanently connected to said means for reinforcing the towel where the metal or plastic eyelet attaches to it;
means for reinforcing the towel where the metal or plastic eyelet attaches to it, permanently connected to said means for drying and covering the surfer or surfboard; and
means for providing a secure means of attaching the plastic spring-loaded clip or metal carabineer to the towel and to hand the towel on a hook, permanently connected to said means for reinforcing the towel where the metal or plastic eyelet attaches to it.

2. The surfing towel assembly with fasteners in accordance with claim 1, wherein said means for drying and covering the surfer or surfboard comprises a terry cloth terry cotton and/or bamboo towel.

3. The surfing towel assembly with fasteners in accordance with claim 1, wherein said means for attaching the surfing towel assembly to a surfer or surfboard comprises a fastening system one: strip #1 (loop in hook and loop fastener).

4. The surfing towel assembly with fasteners in accordance with claim 1, wherein said means for attaching the surfing towel assembly to a surfer or surfboard comprises a fastening system one: strip #2 (hook in hook and loop fastener).

5. The surfing towel assembly with fasteners in accordance with claim 1, wherein said means for reinforcing the towel where the metal or plastic eyelet attaches to it comprises a fastening system two: cloth gusset #1.

6. The surfing towel assembly with fasteners in accordance with claim 1, wherein said means for providing a secure means of attaching the plastic spring-loaded clip or metal carabineer to the towel and to hand the towel on a hook comprises a fastening system two: metal or plastic eyelet #1.

7. The surfing towel assembly with fasteners in accordance with claim 1, wherein said means for reinforcing the towel where the metal or plastic eyelet attaches to it comprises a fastening system two: cloth gusset #2.

8. The surfing towel assembly with fasteners in accordance with claim 1, wherein said means for providing a secure means of attaching the plastic spring-loaded clip or metal carabineer to the towel and to hand the towel on a hook comprises a fastening system two: metal or plastic eyelet #2.

9. A surfing towel assembly with fasteners for coverage, protection, and drying, comprising:
a terry cloth terry cotton and/or bamboo towel, for drying and covering the surfer or surfboard;
a fastening system one: strip #1 (loop in hook and loop fastener), for attaching the surfing towel assembly to a surfer or surfboard, permanently connected to said Terry cotton and/or bamboo Towel;
a fastening system one: strip #2 (hook in hook and loop fastener), for attaching the surfing towel assembly to a surfer or surfboard, permanently embedded to said Terry cotton and/or bamboo Towel;
a fastening system two: cloth gusset #1, for reinforcing the towel where the metal or plastic eyelet attaches to it, permanently connected to said Terry cotton and/or bamboo Towel;
a fastening system two: metal or plastic eyelet #1, for providing a secure means of attaching the plastic spring-loaded clip or metal carabineer to the towel and to hand the towel on a hook, permanently connected to said Fastening System Two: cloth gusset #1;
a fastening system two: cloth gusset #2, for reinforcing the towel where the metal or plastic eyelet attaches to it, permanently connected to said Terry cotton and/or bamboo Towel; and
a fastening system two: metal or plastic eyelet #2, for providing a secure means of attaching the plastic spring-loaded clip or metal carabineer to the towel and to hand the towel on a hook, permanently connected to said Fastening System Two: cloth gusset #2.

10. The surfing towel assembly with fasteners as recited in claim 9, further comprising:
a fastening system two: plastic spring-loaded clip or metal carabineer, for providing a means of attaching one corner of the towel to the other, providing a second means of attaching the towel to a surfer or surfboard as well as attaching the towel to an anchor point such as a car roof rack or hook, detachably connected to said Terry cotton and/or bamboo Towel.
